(19) United States
(12) Patent Application Publication
(10) Pub. No.: US 2007/0026254 A1
(43) Pub. Date: Feb. 1, 2007

(54) Method for processing surfaces of aluminium alloy sheets and strips

(76) Inventors: Mohamed Ben-Malek, St. Martin D'Hares (FR); Evelyne Hank, Moirans (FR); Ravi Shahani, Andolsheim (FR)

Correspondence Address: DENNISON, SCHULTZ & MACDONALD, 1727 KING STREET, SUITE 105, ALEXANDRIA, VA, 22314, US

(21) Appl. No.: 10/558,749

(22) PCT Filed: Jun. 9, 2004
(86) PCT No.: PCT/FR04/01426

§ 371 Date: Dec. 1, 2005

(30) Foreign Application Priority Data
Jun. 11, 2003 (FR) 03/07004

(51) Int. Cl. B32B 15/10; B32B 15/01; C08F 2/46

(52) U.S. Cl. 428/651; 427/496; 977/700

(57) ABSTRACT

A method for processing the surface of a strip, sheet or a shaped part made of an aluminum alloy which involves the preparation of a surface with the aid of an atmospheric pressure plasma and by a chemical conversion treatment using at least the elements Si, Ti, Zr, Ce, Co, Mn, Mo and V, for producing a conversion coating on the strip, sheet or part. The process is more rapid and less costly than previous conversion treatments and is applied, in particular, for strips and sheets which are used for a car body and assembled by welding or gluing.

### DOMAIN OF THE INVENTION

The invention relates to the field of surface treatment of sheets and strips made of an aluminium alloy, and parts stamped from these sheets, and particularly a 6xxx or 5xxx type alloy according to the Aluminum Association, intended particularly for manufacturing bodywork parts for automobile vehicles.

### STATE OF THE ART

Aluminium is increasingly used in automobile construction to reduce the weight of vehicles and therefore fuel consumption and releases of pollutants and greenhouse effect gases. Sheets are used particularly for manufacturing bodywork skin parts, and particularly doors. This type of application requires a set of sometimes contradicting mechanical strength, corrosion resistance and formability properties; with an acceptable cost for mass production.

In Europe these requirements led to the choice of Al—Mg—Si alloys, in other words alloys in the 6000 series for the skin, and Al—Mg alloys in the 5000 series for stiffeners or linings. There are also requirements for the surface condition related to the assembly mode used.

There is no particular requirement about surface quality for the mechanical assembly, except that it should be reasonably clean. Depending on the type of welding being done, welding operations sometimes require a clean (namely degreased) surface so as to reduce porosity and cracks in the welds. However, this is not so critical in the case of laser welding. The surface response is then determined by the value of the contact resistance measured in Europe according to standard DVS 2929.

For structural gluing in aeronautical construction, surfaces are usually pre-treated before gluing, usually consisting of chromic and phosphoric anodisation. Chromium based chemical conversions are used in other application fields such as packaging and buildings. Although these conversions are still frequently used, they are likely to disappear for environmental reasons, due to the concern about the presence of hexavalent chromium. More recent treatments use elements such as silicon, titanium or zirconium to replace chromium. For example, such treatments are described in patents U.S. Pat. No. 5,514,211 (Alcan), U.S. Pat. No. 5,879,437 (Alcan), U.S. Pat. No. 6,167,609 (Alcoa) and EP 0646187 (Boeing).

For automobile structural parts, surface preparation adapted to assembly operations, and particularly gluing and spot welding, may be necessary. These pre-treatments take time and are expensive. The formation of the surface layer requires a series of manipulations of different baths, possibly requiring more than 8 tanks. Thus, a standard treatment line consists of 2 alkaline degreasing baths followed by 2 rinsing baths, an acid neutralisation bath, a special treatment bath, followed by two rinsing baths and a drying step. Most of these baths are heated to up to 60° C., which consumes a large amount of energy.

Therefore the invention is designed to make a pre-treatment on aluminium alloy strips or sheets adapted to the requirements of the automobile industry, by minimising strip or sheet manipulation operations. One particular purpose is to provide ready-to-assemble sheets for car bodywork parts, with high performances for bonding of glues and adhesives used in automobiles and for spot welding and a stable surface quality in the long term.

### PURPOSE OF THE INVENTION

The purpose of the invention is a surface treatment process for a strip, a sheet or a formed part made of aluminium alloy comprising a surface preparation using an atmospheric plasma, and a chemical conversion treatment using at least one of the elements Si, Ti, Zr, Ce, Co, Mn, Mo or V to form the conversion layer.

The conversion treatment may be done using a bath containing between 1% and 10% by weight of at least one salt of at least one of the elements Si, Ti, Zr, Ce, Co, Mn, Mo or V, and in this case the process preferably includes drying with a roller at the end of the treatment. It may be done by immersion in the bath, by atomisation of the bath on the strip, the sheet or the part, or with a roller to apply a coating of the bath using a “no rinse” technique.

The conversion treatment may also be done using an atmospheric plasma in which the plasmagenic gas comprises a compound of at least one of the elements Si, Al, Ti, Zr, Ce, Co, Mn, Mo or V. The element in the compound added to the plasmagenic gas is preferably silicon.

### DESCRIPTION OF THE FIGURES

FIG. 1 shows the results of gluing tests on test pieces made of a 5754 alloy in the 0 temper and a 6016 alloy in the T4 temper treated using the process according to the invention with two baths different from those used in the reference test pieces.

FIG. 2 shows results of the same type obtained on test pieces treated according to the invention with a plasma conversion.

### DESCRIPTION OF THE INVENTION

The invention is based on the observation made by the applicant that when the chemical conversion treatment is preceded by a preparation such as degreasing using an atmospheric plasma, this treatment may be made very much simpler than treatments according to prior art for the same purpose, and that a fast treatment for example of the “no-rinse” type using a conversion bath with roll drying would be sufficient, or alternatively a conversion treatment making use of an atmospheric plasma would be sufficient.

Atmospheric plasma techniques have become much more widespread in recent years and many applications have been suggested, particularly for treatment of metals. For example, patent application WO 02/39791 (APIT Corp.) discloses a process and device for treatment of a conducting surface by atmospheric plasma, and in one of the examples mentions cleaning of an aluminium sheet to removed residues of rolling grease.

A treatment of this type is surprisingly better than usual chemical degreasing treatments for implementation of the subsequent chemical conversion, the plasma being used for degreasing and for modification of natural oxide present on the aluminium surface. It was also found that the atmospheric plasma could also be used for formation of the conversion layer itself, provided that a compound that decomposes to produce the element required for the conversion layer is added to the plasmagenic gas.

By grouping the degreasing and conversion steps, the use of an atmospheric plasma saves a great deal of time and considerably reduces constraints related to treatment of releases.

Finally, it enables treatment rates compatible with advance velocities of aluminium alloy strips at the exit from rolling lines. Thus velocities of 5 m/min to 600 m/min can easily be achieved.

In a first embodiment of the process according to the invention, the chemical conversion treatment is preferably made using a solution containing metallic elements such as Si, Ti, Zr, Ce, Co, Mn, Mo, V, or other combinations of these elements, for example a Ti/Zr product capable of reacting with the metal surface chemically to form an oxide layer more stable than natural oxide. It was observed that this operation can be performed even though the strip, sheet or part only remains in contact with the liquid for a very short time. In the case of strips, this enables in line treatment compatible with production velocities of these strips.

It is preferable to exclude reagents containing chromium to avoid the possible formation of products containing hexavalent chromium. Additives are present in treatment baths in very low concentration, less than 10% and preferably between 1% and 5%. Similarly, the aggressiveness of the bath in terms of acidity is limited by using baths with a pH of between 3 and 11.

The oxide formed combines aluminium and also the element present in the bath. Many bath compositions are available on the market, such as bath compositions containing titanium, zirconium, cerium, cobalt, manganese, vanadium salts or compounds containing silica.

After contact treatment in the bath, the sheet or the part is preferably dried with a roller using the so-called “no-rinse” technique known to those skilled in the art, this technique being particularly suitable for continuous treatment of the strips.

The layers formed may be controlled by weighing, X-fluorescence or ESCA analysis, the latter two techniques providing information about the constituents of the layer and also, for ESCA, about chemical bonds in which the elements are involved.

The oxide is very thin, within the 5 to 50 nm range. The ESCA analysis can give an estimate of the oxide layer if it is thinner than about 6 nm and if the surface contamination is low. The surface is usually covered with a layer of contamination carbon that disturbs the measurement. A more precise measurement can be obtained if transmission electronic microscopy is used after the test piece has been prepared by microtomy. This technique can be used to calibrate measurements made by ESCA.

A contact resistance measurement can also be used. With the process according to the invention, this resistance is less than 20 or even 15 μΩ, which is compatible with requirements in the automobile industry.

In a second embodiment of the invention, the conversion layer is obtained by a second pass in an atmospheric plasma, the plasmagenic gas, for example air, argon or a mix of a rare gas plus oxygen. The plasmagenic gas is enriched by a compound that decomposes to give a metallic element among Si, Al, Ti, Zr, Ce, Co, Mn, Mo and V, required in the conversion layer. One of the most efficient elements is silicon that leads to an SiOₓ type conversion layer, where x is approximately equal to 2. For example, silicon may originate from the decomposition of an organic compound containing silicon, or silicon and oxygen, such as tetra-ethyl-disiloxane, tetra-methyl-disiloxane, hexa-methyl-disiloxane or hexamethyldisilazane, mixed with argon used for the plasmagenic mix.

The oxide layer obtained with this embodiment comprises a layer with a uniform thickness of 10 to 30 nm, on which a set of nanoball aggregates more or less bonded to each other is deposited, with an extra thickness possibly exceeding 200 nm.

It may be assumed that this structure of the oxide layer is due to its formation in two successive steps. Firstly, there is the growth of a uniform and continuous barrier layer in which silicon combines with oxygen, and possibly other elements on the surface to form an amorphous deposit, followed by the growth of silica nanoballs forming aggregates that are larger when the number of passes (equivalent to a longer transit time of the surface in front of the plasma) is higher. These aggregates contribute to improving the bond of the base oxide layer in case of gluing, by providing mechanical anchorage.

The results obtained with the process according to the invention are as good as a conventional treatment including a pass in degreasing, stripping and rinsing baths, but the treatment takes less time and is less expensive. This is even more noticeable when a “no-rinse” type conversion or a plasma conversion is used, which avoids a pass in a rinsing bath. Finally, the use of chromium-free compounds is kinder towards the environment and simplifies the treatment of effluents.

### EXAMPLES

### Example 1

Test pieces of 1 mm thick sheets made of AA5754 aluminium alloy in the 0 temper (annealed), and 1.2 mm thick sheets made of AA6016 alloy in the T4 temper, were produced. The test pieces were degreased by atmospheric plasma treatment using an instrument made by the Plasma Treat GmbH company, with the operating parameters given in table 1:

TABLE 1

| | |
|---|---|
| Working frequency | 16-20 kHz |
| Working voltage | 5 kV |
| Plasma power | 1000 W |
| Plasma generator | FG1001 minimum |
| High voltage transformer | HTR1001 |
| Treatment width | 5 mm per nozzle and up to |
| | 120 mm by rotation of 2 |
| | nozzles |
| Nozzle rotation speed | 2000 rpm |
| Treatment rate | 5 m/min |
| Nozzle - surface distance | 15 and 20 mm |
| 5-7 bars compressed air | 20 l/min (1.2 Nm³/h) |
| filtered and deoiled | |

The plasma treatment is done by several passes in front of the torch to accumulate energy on the metal while avoiding an excessive temperature rise that could lead to initiating melting.

After plasma treatment, the ESCA analysis shows a net reduction in the carbon layer that changes from 40-50% of carbon on the surface to 25-30%. This value may still appear high, and is probably related to the fact that the test pieces are analysed after passing into air. The thickness of the oxide layer changes from a value between 3 and 5 nm to a value between 6 and 8 nm depending on the alloy. The ESCA analysis also indicates enrichment of the surface oxide with magnesium, magnesium oxide accounting for almost a third of the surface oxide, but paradoxically this magnesium content does not appear to hinder the bond, unlike what is normally accepted.

The test pieces were then immersed for 5 s in a treatment tank containing the bath, and were then dried manually using a roller, the roller being wiped after each operation. The following products were used for the bath:

A) Gardobond® X4591 by Chemtall, based on titanium and zirconium salts.

B) Alodine® 2040 by Henkel based on titanium salts

C) Dynasylan® Glymo (3-glucidyl-oxy-trimethoxy-silane) by Degussa.

The ESCA analysis shows that the three products lead to conversion layers practically identical to those obtained by a conventional conversion. Product C is associated with a slightly higher surface carbon content that can be assigned to the precursor carbonaceous chains being held in the silicon oxide.

Bonding tests were performed with 150 mm long treated test pieces regreased with Quaker DC 1 55/45 dry lubricant, using the wedge cleavage test according to standard EN 30354, slightly modified for use with alloys intended for use for automobile bodywork; the wedge is made to penetrate half-way to avoid dissipating energy too quickly, and the test piece is glued onto a test piece the same size made of a 2017 alloy in the T4 temper to increase the stiffness of the assembly. Ageing is done in a climatic chamber at 50° C. and at a relative humidity equal to 100% for durations of 1, 5, 24, 48 and 96 hours respectively. Crack propagation is observed on both faces with binoculars after allowing the test pieces to rest at ambient temperature for 1 hour. An average propagation is deduced from each group of three test pieces.

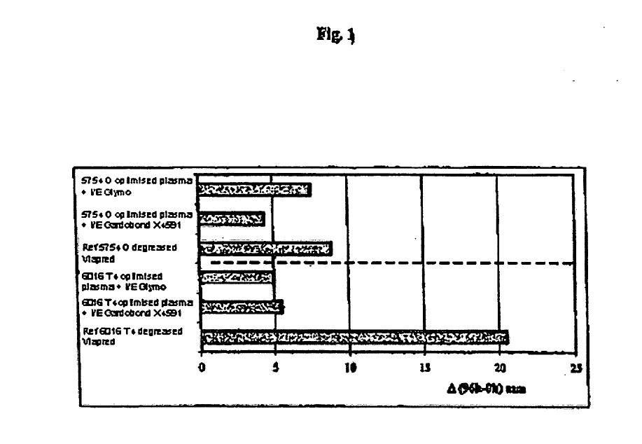

FIG. 1 shows crack propagation for the conversion layers produced according to the invention with a bath containing products A and C, and for reference test pieces degreased with Viapred solvent made by the SID company (product D). It is observed that test pieces treated according to the invention have a better behaviour than when treated according to the reference treatment, and are therefore suitable for gluing, for all types of alloys used.

### Example 2

Test pieces of 1 mm thick sheets made of AA5182 aluminium alloy in the 0 temper (annealed), and 1.2 mm thick sheets made of AA6016 alloy in the T4 temper, were produced. The test pieces were degreased by atmospheric plasma treatment using an instrument like that described in patent application WO 02/39791, and using hexamethyldisilazane as the reactive gas.

The plasma treatment takes place in two steps:
degreasing: several passes are made in front of the torch to store energy in the metal, while avoiding overheating that could cause structural modification of the metal or initiating melting,
deposition of a layer of silicon oxide compound SiOx with a stoichiometry of approximately 2.

After plasma treatment, the ESCA analysis for which the results are given in table 2, clearly shows the presence of this silicon oxide layer. Its thickness depends on treatment conditions. Thus, thicknesses of 100 to 300 nm were deposited using the atmospheric plasma technique. This layer conceals other elements present on the outer surface of the metal, but elements such as Al and Mg can still be detected for small thicknesses.

TABLE 2

| Test Piece | C1s | | O1s | | MgKLL | | Al2p | | Si2p | |
|---|---|---|---|---|---|---|---|---|---|---|
| and treatment | m | σ | m | σ | m | σ | m | σ | m | σ |
| 5182 O SiO2#1 | 17.94 | 2.95 | 57.37 | 2.04 | 0.76 | 0.10 | 0.34 | 0.17 | 23.58 | 0.94 |
| 5182 O SiO2#2 | 15.26 | 2.04 | 59.63 | 1.63 | 0.66 | 0.29 | 0.56 | 0.34 | 23.88 | 0.52 |
| 5182 O SiO2#3* | 10.50 | 0.75 | 63.64 | 1.03 | 0.50 | 0.32 | 0.49 | 0.20 | 24.87 | 0.46 |
| 6016 SiO2#1 | 10.81 | 3.11 | 63.51 | 2.46 | 0.23 | 0.10 | 0.87 | 0.54 | 24.58 | 0.96 |
| 6016 SiO2#2 | 10.00 | 0.49 | 63.93 | 0.50 | 0.36 | 0.05 | 0.89 | 0.35 | 24.82 | 0.32 |
| 6016 SiO2#3 | 13.91 | 2.20 | 60.76 | 1.64 | 0.50 | 0.07 | 1.53 | 0.27 | 23.29 | 0.78 |
| 5182 H22 SiO2#1 | 16.20 | 2.06 | 59.00 | 1.03 | 0.86 | 0.24 | 0.86 | 0.28 | 23.07 | 1.30 |
| 5182 H22 SiO2#2 | 32.38 | 11.33 | 48.50 | 8.12 | 1.41 | 0.31 | 0.71 | 0.22 | 17.00 | 3.76 |
| 5182 H22 SiO2#3 | 53.27 | 9.75 | 33.48 | 7.07 | 5.82 | 1.42 | 6.45 | 2.25 | 0.98 | 0.70 |

The table gives atomic percentages of elements on the surface of the test pieces.

Values for test piece 5182-H22 SiO2#3 are different from the values for other test pieces. The carbon content is high whereas there is practically no silica on the surface. This test piece was analysed on the untreated surface, which confirms the effect of stripping and the treatment. The other variations in the carbon content can be assigned to contamination during manipulation of the treated plates. However, detection of significantly higher quantities of the Al and Mg elements could indicate that the thickness is slightly smaller.

Bonding tests were performed with 150 mm long treated test pieces bare or regressed with Quaker's DC 1 55/45 or Ferrocoat® 6130 lubricants, using the wedge cleavage test according to standard EN 30354, slightly modified for use with alloys intended for use for automobile bodywork; the wedge is made to penetrate half-way to avoid dissipating energy too quickly, and the test piece is glued onto a test piece the same size made of a 2017 alloy in the T4 temper to increase the stiffness of the assembly. Ageing is done in the climatic chamber at 50° C. and at a relative humidity equal to 100% for durations of 1, 5, 24, 48 and 96 hours respectively. Crack propagation is observed on both faces with binoculars after allowing the test pieces to rest at ambient temperature for 1 hour. An average propagation is deduced from each group of three test pieces.

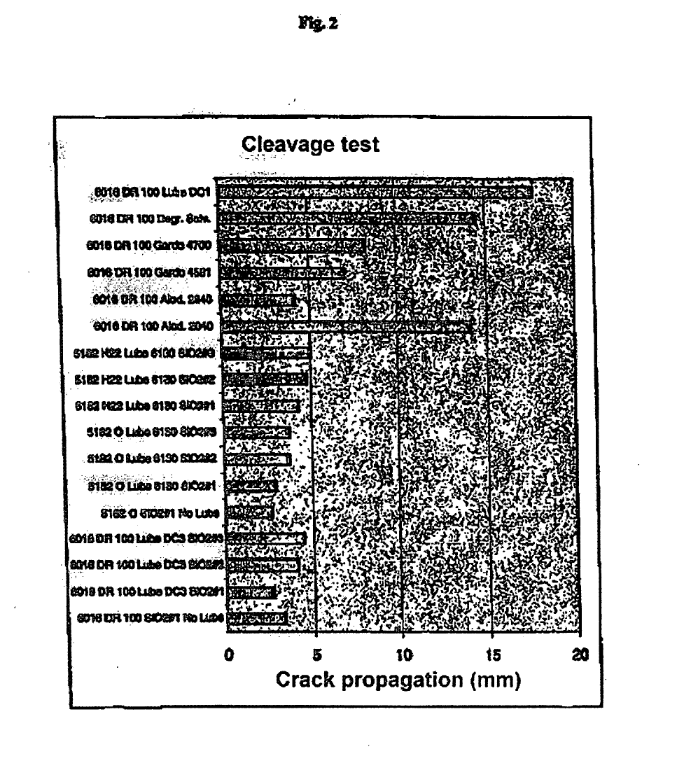

FIG. 2 shows crack propagation for the atmospheric plasma deposits made on the 6016 and 5182 alloys used with or without a lubricant, and for reference test pieces chemically converted using process currently used at some automobile manufacturers. It is observed that the treated test pieces have a better behaviour than when treated according to the reference treatment for all types of alloys used. Bonding with no lubricant applied immediately after treatment gives a slightly better result. Similarly, the 5182 alloy in the 0 temper behaves slightly better than in the H22 temper. Bonding operations for plates coated with lubricant were done after storage in the lubricated state for a period of more than one and a half months in the normal laboratory atmosphere. This demonstrates the robustness of the atmospheric plasma treatment that very much improves the surface properties of the metal. This surface quality is also demonstrated through observation of failure surfaces in the cleavage test. Unlike other treatments for which an adhesive rupture (RA) is sometimes observed, in other words a failure at the surface oxide—adhesive interface, in this case there are always cohesive ruptures (RC), in other words ruptures that occur in the adhesive or close to its surface (superficial cohesive rupture).

Table 3 shows the rupture mode for glued joints during the cleavage test.

TABLE 3

| Case tested | Δ96-0 | origin | 5 h | 48 h | 96 h | End |
|---|---|---|---|---|---|---|
| 6016 SiO2#1 No lube | 3.3 | RC | RC | RC | RC | RC |
| 6016 SiO2#1 DC3 | 2.7 | RC | RC | RC | RC | RC |
| 6016 SiO2#2 DC3 | 4.1 | RC | RC | RC | RC | RC |
| 6016 SiO2#3 DC3 | 4.5 | RC | RC | RC | RC | RC |
| 5182 O SiO2#1 No lube | 2.7 | RC | RC | RC | RC | RC |
| 5182 O SiO2#1 6130 | 2.9 | RC | RC80 | RC80 | RC80 | RC |
| 5182 O SiO2#2 6130 | 3.6 | RC | RC90 | RC85 | RC85 | RC |
| 5182 O SiO2#3 6130 | 3.7 | RC | RC | RC | RC | RC |
| 5182 H22 SiO2#1 6130 * | 4.3 | RC | RC | RC | RC | RC |
| 5182 H22 SiO2#2 6130 * | 4.8 | RC | RC | RC | RC | RC |
| 5182 H22 SiO2#3 6130 * | 5.1 | RC | RC95 | RC | RC | RC |
| 6106 Alodine. 2040 DC1 | 14.1 | RC | RA | RA | RA | RC |
| 6106 Alodine. 2840 DC1 | 4.2 | RC | RC | RA | RA | RC |
| 6016 DR100 Gardobond | 7.1 | RC | RC | RA | RA | RC |
| 4591 DC1 | | | | | | |
| 6016 DR100 Gardobond | 8.3 | RC | RC | RA | RA | RC |
| 4700 DC1 | | | | | | |
| 6016 Degr. Solv. DC1 | 14.5 | RC | RA75 | RA | RA | RC95 |
| 6016 Lube DC1 | 17.8 | RC | RA55 | RA | RA | RC95 |

1. Process for the surface treatment of a strip, a sheet or a stamped part of a sheet or a strip made of an aluminium alloy consisting of a surface preparation using an atmospheric plasma and a chemical conversion treatment using at least one of the elements Si, Ti, Zr, Ce, Co, Mn, Mo or V to form the conversion layer on the strip, the sheet or the part.

2. Process according to claim 1, characterised in that the aluminium alloy is an alloy in the 5000 series or 6000 series.

3. Process according to claim 1, characterised in that the conversion treatment is done using at least one salt of one of at least the said elements.

4. Process according to claim 3, characterised in that the conversion treatment is done by immersion in the bath.

5. Process according to claim 3, characterised in that the conversion treatment is done by atomisation of the bath on the strip, the sheet or the part.

6. Process according to claim 3, characterised in that the conversion treatment is done by coating the strip, the sheet or the part with the bath.

7. Process according to claim 3, characterised in that the treatment bath has a pH of between 3 and 11.

8. Process according to claim 1, characterised in that the conversion treatment is done using an atmospheric plasma using a plasmagenic gas including a compound of at least one of the elements Si, Al, Ti, Zr, Ce, Co, Mn, Mo or V.

9. Process according to claim 1, characterised in that the treatment rate is from 5 m/min to 600 m/min.

10. Process according to claim 1, characterised in that the conversion layer has a thickness of between 5 and 300 nm.

11-12. (canceled)
